(19) United States
(12) Patent Application Publication
(10) Pub. No.: US 2009/0299817 A1
(43) Pub. Date: Dec. 3, 2009

(54) MARKETING AND ADVERTISING FRAMEWORK FOR A WIRELESS DEVICE

(75) Inventors: Kenny FOK, San Diego, CA (US); Eric Chi Chung Yip, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/132,491

(22) Filed: Jun. 3, 2008

(51) Int. Cl. G06Q 30/00; G06F 17/30

(52) U.S. Cl. 705/10; 705/14.52

(57) ABSTRACT

Targeted advertising can be provided by monitoring application specific details that go beyond observing merely the types of applications and/or functionality utilized on a device. The specific details can be monitored on at least a periodic basis and the advertisements changed based on the monitoring such that the advertisements transition from generic advertisements to advertisements that are more narrowly tailored for the user. The targeted advertisements can be retained locally on the user device, accessed over a network, or combinations thereof. Presenting the targeted advertisements can include displaying the advertisements in at least a portion of a display screen, wherein the portion is selectable and changeable.

### BACKGROUND

I. Field

The following description relates generally to wireless communication systems and more particularly to a targeted marketing and advertising framework for use within a wireless communication system.

II. Background

Technological advances have resulted in smaller and more powerful personal computing devices. For example, there exists a variety of portable personal computing devices, including wireless computing devices, such as portable wireless telephones, personal digital assistants (PDAs) and paging devices that are each small, lightweight, and can be easily carried by users. Consumers are increasingly offered many types of electronic devices that can be provisioned with an array of software applications. Distinct features such as email, Internet browsing, game playing, address book, calendar, media players, electronic book viewing, voice communication, directory services, and so forth, increasingly are selectable applications that can be loaded on a multi-function device, such as a smart phone, portable game console, hand-held computer, and so on.

With these technological advances, more and more people are receiving the bulk of their communication on these personal computing devices. For example, newspapers and magazines are moving towards electronic versions that can be displayed directly on the personal computing device. Movies, television shows, and other forms of entertainment can be received at the mobile device, upon demand. The changes to more personal and on-demand versions present a problem as it relates to advertisements. For example, generic advertisements are simply ignored, closed, or otherwise removed from a display screen. Advertising companies and wireless service providers would like to deliver targeted advertisement to these users, wherein the advertisements are both meaningful to the user and have a greater chance of being viewed and/or acted upon.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection with a framework to deliver targeted advertisements to wireless device users based on application specific data. The application specific data can be viewable data, hidden data, or combinations thereof.

According to an aspect is a method for providing targeted advertisements. The method includes monitoring application specific data and gathering the data to categorize the data, characterize a user, characterize an endeavor, or combinations thereof. The method also includes determining an advertisement that is targeted for the user based on the application specific data and outputting the targeted advertisement.

Another aspect relates to a wireless communications apparatus that includes a memory and a processor. The memory retains instructions related to capturing application specific details and utilizing the captured application specific details to characterize a user, characterize an endeavor, categorize an application, or combinations thereof. The memory also retains instructions relating to choosing one or more advertisements based on one or more of the characterization and categorization and outputting the one or more advertisements. The processor is coupled to the memory and is configured to execute the instructions retained in the memory.

A further aspect relates lo a communications apparatus that includes a means for observing specific data associated with one or more applications and a means for classifying the specific data, a user, an endeavor, or combinations thereof. The communications apparatus also includes a means for selecting a targeted advertisement based on the classification and a means for presenting the targeted advertisement.

Another aspect relates to a computer program product for providing targeted advertisements. The computer program product comprises a computer-readable medium that includes instructions. A first instruction is operable to cause a computer to collect application specific details and a second instruction is operable to cause a computer to evaluate the application specific details to distinguish user activities. Further, a third instruction is operable to cause a computer to select one or more advertisements targeted for a user based on the evaluated details and at least a fourth instruction is operable to cause a computer to output the one or more advertisements to the user.

Yet another aspect relates to at least one processor configured for providing targeted advertisements. The processor comprises a first module for monitoring application specific data and a second module for gathering the application specific data to categorize the data, characterize a user, characterize an endeavor, or combinations thereof. The processor also comprises a third module for determining an advertisement that is targeted for the user based on the gathered data, a fourth module for obtaining (e.g., collecting, receiving) and generating reports related to the gathered data and the targeted advertisement, and a fifth module for outputting the targeted advertisement. Further, the processor comprises a sixth module for continuing to monitor the application specific data, at least periodically, and a seventh module for requesting a change to the targeted advertisement based on the monitoring. The targeted advertisement can be retained locally on a user device, accessed through a network, or combinations thereof.

A further aspect relates to a method for providing targeted advertisements. The method includes receiving application specific data from a mobile device and mapping the application specific data to a targeted advertisement. The method also includes sending the targeted advertisement to the mobile device for presentation to a user if the application specific data was mapped to an advertisement.

Another aspect relates to a wireless communications apparatus that includes a memory and a processor. The memory retains instructions related to receiving application specific data from a mobile device and mapping the application specific data to a targeted advertisement. The memory also retains instructions related to sending the targeted advertisement to the mobile device for presentation to the user if the application specific data was mapped to an advertisement. The processor is coupled to the memory and is configured to execute the instructions retained in the memory.

Yet another aspect relates to a communications apparatus that comprises a means for receiving application specific data from a mobile device and a means for mapping the application specific data to a targeted advertisement. The apparatus also includes a means for sending the targeted advertisement to the mobile device for presentation to a user if the application specific data was mapped to an advertisement.

Still another aspect relates to a computer program product for providing targeted advertisements comprising a computer-readable medium. The computer-readable medium comprises a first instruction operable to cause a computer to receive application specific data from a mobile device and a second instruction operable to cause the computer to map the application specific data to a targeted advertisement. The computer-readable medium also comprises a third instruction operable to cause the computer to send the targeted advertisement to the mobile device for presentation to the user if the application specific data was mapped to an advertisement.

A further aspect relates to at least one processor configured for providing targeted advertisements. The processor comprises a first module for receiving application specific data from a mobile device and a second module for mapping the application specific data to a targeted advertisement. The processor also comprises a third module for sending the targeted advertisement to the mobile device for presentation to the user if the application specific data was mapped to an advertisement.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of the various aspects may be employed. Other advantages and novel features will become apparent from the following detailed description when considered in conjunction with the drawings and the disclosed aspects are intended to include all such aspects and their equivalents.

### BRIEF DESCRIPTION OF THE DRAWINGS

FIG. 1 illustrates a mobile device that can selectively provide targeted advertising based on application specific data.

FIG. 2 illustrates another wireless communication device in accordance with one or more of the disclosed aspects.

FIG. 3 illustrates viewable data and hidden data as represented in a timeline for an example gaming application.

FIG. 4 illustrates an example time line for a keypress utilized by a gaming application.

FIG. 5 illustrates another example timeline of information relating to a mapping application

FIG. 6 illustrates a communication system in accordance with the one or more disclosed aspects.

FIG. 7 illustrates an exemplary version of a communication system.

FIG. 8 illustrates a method for providing advertisements targeted for a user based on detailed application data.

FIG. 9 illustrates a method for determining one or more advertisements to present to a user.

FIG. 10 illustrates a method for providing targeted advertisements.

FIG. 11 illustrates an example system that provides targeted advertising in accordance with the one or more aspects described herein.

FIG. 12 illustrates an example system that provides targeted advertising in accordance with the one or more aspects described herein.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing these aspects.

As used in this application, the terms “component”, “module”, “system”, and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Furthermore, various aspects are described herein in connection with a wireless terminal. A wireless terminal can also be called a system, subscriber unit, subscriber station, mobile station, mobile, mobile device, device remote station, remote terminal, access terminal, user terminal, terminal, wireless communication device, user agent, user device, or user equipment (UE). A wireless terminal may be a cellular telephone, a cordless telephone, a Session Initiation Protocol (SEP) phone, a smart phone, a wireless local loop (WLL) station, a personal digital assistant (PDA), a laptop, a handheld communication device, a handheld computing device, a satellite radio, and/or another processing device for communicating over a wireless system. Moreover, various aspects are described herein in connection with a base station. A base station may be utilized for communicating with wireless terminal(s) and may also be referred to as an access point, Node B, or some other terminology.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

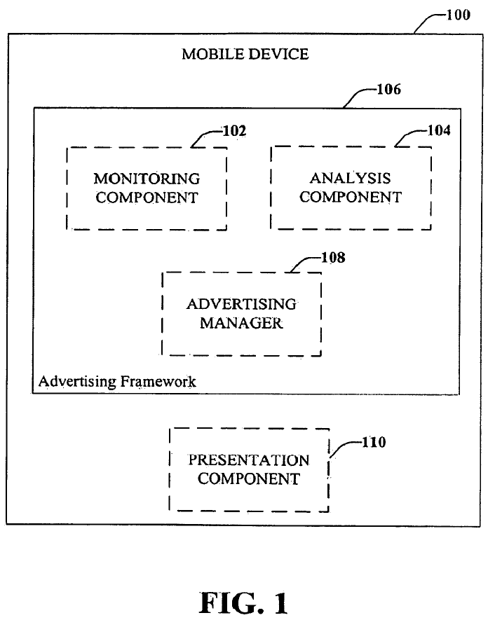

Referring now to FIG. 1, illustrated is a mobile device 100 that can selectively provide targeted advertising based on application specific data. As a user operates a mobile device, usage trends of various applications, functions and/or interactions of the user with the device can be monitored. Based in part on the monitoring, advertisements can be rendered on the device, wherein the advertisements are targeted to the specific user. Over time, the monitoring can be continuous to allow more focused (or targeted) advertising to be specified such that the advertisements rendered can transition from generic advertisements to specific (e.g., tailored) advertisements. Thus, the advertisements can be more personalized since the interactions with (and specific details of) the various applications are utilized rather than just the types of applications.

As used herein, application specific data relates to data utilized by a particular program or application and which is useful in a meaningful way within that application and/or to a processing subsystem. The application specific data can be data that the application generates, data the application gathers, data that a user is asked to input or supplies based on interactions with the application, data used in execution of an application, and so forth. The data can be separated into user viewable data and hidden data. A high score in a gaming application is an example of viewable data. Hidden data is information that is not viewable or consciously needed (or input) by the user (e.g., data hidden from a user. Examples of hidden data include how much Internet bandwidth is needed for the application, how long a program was running, a collection of key strokes, and so forth.

For example purposes and not limitation, a device user has a gaming application (e.g., shooting game) on the device. The games played by the user can have information, such as high scores, skill level, and so forth, which can be information directly obtained or otherwise derived from the application-specific gaming application. This information can be utilized to present or output an advertisement, such as a shooting game championship competition, if it is detected that the user has an average or higher than average skill level. In another example, the user can be presented advertisements for training classes that the user might be interested in attending in order to increase a lower than average skill level. Thus, the advertisements presented can go beyond the type of application (e.g., gaming application) and the fact that the user is accessing the application, but can also be based on application specific data (e.g., skill level of the user, scores) in order to be tailored for the user.

Hidden data can be divided into data is that known by an application and data that is not know by an application but is known by one or more processing subsystems. Examples of hidden data not known by an application (but known by processing subsystems) can include background processes or applications and/or how much memory is used during a particular time or while various programs are being utilized. Another example includes how many times a user paused a game. The number of pauses is not needed for the functionality of the gaming application or for the ability of the user to use the program. However, this information can be utilized and/or can contribute to how to advertise, how to change the manner of advertising, and so forth. The data known by processing subsystems but not the application can be utilized either separately or in conjunction with other application specific data to tailor advertisements in accordance with the disclosed aspects.

Mobile device 100 can include a monitoring component 102 that can be configured to observe application specific data, which can relate to how the application is being consumed by a user and/or other activities of mobile device 100. Monitoring component 102 can also be configured to observe the various activities and/or actions performed by the user. The applications can be any applications and/or functions retained internally in device 100 and/or accessible by device 100, such as over a network. The applications can include, but are not limited to email applications, instant messaging applications, spreadsheet applications, word processing applications, gaming applications, calendar applications, and so forth. The activities or actions can relate to the details of the user interactions with the applications/functions. The activities or actions may include, but are not limited to, user details such as: what application is used, for how long, how often, in what location, and application-specific data corresponding to the user experience. For example, a user might use a gaming application, such as a pool-shooting game, a bowling game, and a hunting game. Over time, monitoring component 102 can determine that one of the games is a preferred game (e.g., pool-shooting game). For example, this determination can be made based on the number of games played, the amount of time played, based on application specific data, or based on other criteria, including user-defined criteria. By utilizing application specific data, for example, monitoring component 102 can determine that for the pool-shooting game the user is using the most difficult level. This information can be utilized to suggest an advertisement for more advanced versions of the game or for advanced features.

In another example, the bowling game might be launched more often, however, monitoring component 102 determined that for the pool shooting game the user played at the highest level of difficulty, even though this game was not launched as often as the bowling game. This information can be combined with the fact that the pool shooting game had the longest duration of play time and had the highest difficulty. Thus, monitoring component 102 can conclude that the user might be interested in a more advanced version of the game. Thus, it is data specific to the application that monitoring component 102 utilizes to make its conclusion, rather than just simply comparing applications (e.g., the three gaming applications).

In accordance with some aspects, the application specific data may include data that is hidden from the application but that is known to processing subsystems. For example, a user has requested a mapping application to view a current location. Hidden data related to the mapping application can include geographic coordinates that are not provided to the user. The mapping application is aware of the geographic coordinates and can present the user with the correct map based in part on the geographic coordinates. However, the mapping application might not be aware of some application specific data such as, the number of satellites utilized to determine a current user position, a GPS algorithm utilized to obtain the geographic coordinates, as well as other data. A processing subsystem can be aware of the number of satellites, the GPS algorithm, and so forth. The application specific data that is known by the processing subsystem can be stored in a retrievable format.

Based on the observations made by monitoring component 102, an analysis component 104 can be configured to gather the observed information and categorize the information, characterize the user (e.g. user preferences, user demographics), characterize the endeavor (e.g., is the device used for business purposes, personal purposes, or both purposes), or combinations thereof. Analysis component 104 can further be configured to analyze trends and/or statistical analysis associated with the applications. For example, the various applications can be grouped into categories (e.g., business, management, personal, and so forth). The application specific data or observed information can be added to the groupings and can be applied across multiple applications. Based on groupings, a trend, if any, can be determined. The trend can indicate changes in the user's behavior or commonality among applications, such as different applications that are utilized for a similar purpose. An example is a word processing application in which the word “math” or its equivalents are utilized often and an algorithm application in which square root calculations are frequently performed. Both the “math” terms and the square root calculations can indicate a trend that the applications are utilized for a similar business or financial purpose. In a gaming application example, statistical analysis can include the skill level of the user, the playing preferences of the user (e.g., solitaire game, more than one player, playing speed, layout of the game, sound preferences, and so forth), as well as other data.

Monitoring component 102 and/or analysis component 104 can be included within an advertising framework 106. However, in accordance with some aspects, either or both monitoring component 102 and analysis component 104 can be components distinct from advertising framework 106. In order to output targeted advertising, advertising framework 106 can be configured to selectively communicate the user application information to content providers and/or third parties in order for such content providers/third parties to analyze marketing techniques and/or trends. The communication can be facilitated through trusted components that can utilize authentication credentials and other means of retaining confidentially and security.

An advertising manager 108, associated with advertising framework 106, can be configured to determine which advertisements should be obtained or presented to the user based on the information from monitoring component 102 and/or analysis component 104. In an alternative aspect, advertising manager 108 may coordinate reception of such targeted advertisements under direction of a network-side component that has performed the determination. In any case, such determination can take into account parameters, such as the portions of application specific data that have more relevance to the user. For example, for a word processing application, generic advertisements for creating letters and other documents (e.g., increasing writing proficiency) can be originally supplied to and/or retained on device 100. Over time as data is gathered, it might be discovered that the word processing application is utilized to create charts and to write technical documents. Thus, the generic ads can be replaced with ads directed to the charts and the technical documents, which are tailored for the user and the manner for which the user is interacting with the word processing application.

A presentation component 110 is configured to selectively render the selected advertisements. The selected advertisements can be cached on mobile device 100 or can be obtained over a network, such as a wireless communication network. Presentation component 110 can select an appropriate manner of rendering the advertisement. For example, a decision can be made whether to render the ad on a display and/or whether the advertisement should fill the entire display or screen area or only a portion of the display area. In accordance with some aspects, a predetermined or preconfigured (e.g., user selectable) area of the screen is dedicated to the rendering of targeted advertisements. According to some aspects, the advertisement can be presented in a pop-up manner in a designated area of the screen. In accordance with other aspects, the advertisement can be presented as an audible advertisement with no associated visual presentation. According to some aspects, the advertisement is presented in both audio and visual format.

The decision of how to render the advertisement can be made by presentation component 110 based on the type of advertisement, the preferences of the user, and/or the preferences of the advertiser. Other determination criteria can include the inferred importance of the advertisement to the user and how receptive the user will be toward the ad (e.g., the more receptive, the more subtle the ad can be). The likelihood that the user is receptive to the ad can be based on current or historical user behavior, or based on other parameters, such as a user indication of a willingness to receive advertisements, the user's actions with respect to a similar advertisement, and so forth.

Thus, mobile device 100 can be configured to enable targeted advertising based on application specific data. The advertising can be targeted based on user actions, preferences, and behaviors as well as data consumed by the user of mobile device 100 in the process of interacting with one or more applications. Further, the application specific information can include activities performed in a particular application, data related to application activities, as well as data generated by a user. The application specific data can also include hidden data that is known to an application and/or known to one or more processing subsystems.

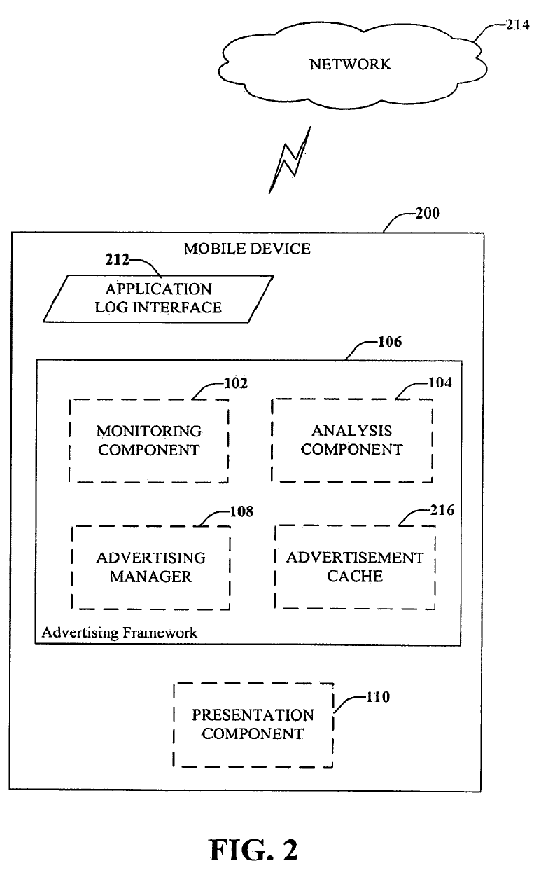

FIG. 2 illustrates another wireless communication device 200 in accordance with the disclosed aspects. Device 200 can obtain usage and statistical information from applications and utilize the obtained information as a basis for presenting advertisements to a user. Device 200 includes a monitoring component 102 that observes the applications accessed and observes application specific data (both viewable data and hidden data). Also included on device 200 is an analysis component 104 that reviews the observed information for trends or other user specific data that can be utilized to tailor one or more advertisements for presentation to the user. Either or both monitoring component 102 and analysis component 104 can be components of an advertising framework 106, which can selectively communicate the user application information to content providers and/or third parties. An advertising manager 108 is also included in advertising framework 106 and can determine one or more advertisements that should be obtained or accessed based on the monitored activities and the analysis of those activities. The selected advertisements can be output to the user by presentation component 110. The advertisements can be rendered in various formats, including visual format and/or audio format. Analysis component 104 can also determine when the ad should be presented (e.g., which functions the user should be performing when the ad is presented, whether the ad should be presented when an application is opened, closed, after a predefined interval of use, and so forth).

Also included on device can be an application log interface 212 that can selectively receive and/or gather and generate reports relating to the application and/or application specific data, trends, and so forth. These reports can be transmitted over the network 214 to an advertising monitoring and/or advertisement supplying destination. The advertisement destination can further analyze the information provided and selectively supply one or more ads to be sent to the device 200. The selection can be based on similar trends of other users (which could have been obtained anonymously) and/or receptiveness of other users to similar ads, which can be determined based on whether another user with similar behaviors, trends, usage of applications, and so forth, clicked on an ad, purchased a product, or performed another function as a result of being presented with a particular ad.

Application log interface 212 can obtain the advertisements at various intervals such as during a device “idle” time or during other limes (e.g., on the fly when a new behavior or trend is discovered). The obtained advertisements can be retained in an advertisement cache 216. In accordance with some aspects, ads can be retrieved from network 214 (e.g., advertisement supplying destination, advertisement supplier) on an as-needed basis (e.g., on the fly), based on assumptions of certain activities performed (e.g., installing a particular application), as well as other criteria.

According to some aspects, there can be generic advertisements originally downloaded to device 200, then, as application specific data is obtained and application log interface 212 selectively transmits information, the various advertisements that are supplied to device 200 can be tailored for the user. In accordance with some aspects, the generic advertisements can be discarded or removed from the advertisement cache 216 as tailored advertisements are obtained. Thus, the advertisements rendered can be generic advertisements and then, as application specific data is obtained, die advertisements can progressively become more specific or tailored for the user.

The advertising manager 108 can aggregate statistics “on the fly”. For example, if the user is playing a movie video, suggestions (e.g., advertisements) of other videos that might be of interest to the user can be presented at substantially the same time as the video is being viewed. These advertisement could he advertisements that were previously received, through application log interface 212 and saved in advertisement cache 216 or ads that are retrieved from network 214 as advertising manager 108 selects the ads and/or as determined through other means (e.g., advertising destination, advertisement supplier).

In another example, the user might like a certain actor or actress; however, if the content for a movie is being downloaded over the network 214, it can take some time for a server to push advertisements relating to that actor/actress to the device. However, based on previously observed behaviors, answers to questions posed in a questionnaire, and through other means (e.g., advertising destination), the application log interface 212, included in device 200, can have previously received advertisements, which can be directly presented to the user. The advertisement could have been received during an “idle” period or at some other time. For example, at substantially the same time as the user is searching for “movies”, a pop-up ad (e.g., to purchase a movie, to view a website) can be presented that relates to the actress liked by the user. The ad can be presented quickly since there is no need to download the advertisement from the network since the advertisement has been retained on the device 200, such as in advertisement cache 216.

Advertising manager 108 can modify the type of advertisements requested and presented and can further remove from cache 216 advertisements that are not of interest to the user. Thus, if a user hovers (e.g., with a mouse or other pointing device) over a particular thumbnail for a news program for a longer time than the user hover time for another news program thumbnail, advertising manager 108 can infer that the news program with the longer hover time is of more interest to the user. Thus, advertisements relating to that news program can be presented, as well as advertisements sponsored or associated with that news program. The thumbnail or hover information is an example of data that is not viewable to the user (e.g. hidden data) but is application specific data that is gathered. Network 214 might not have this information unless the user requested a news clip or other information for that news network directly from the network 214, thus, advertising manager 108 can enhance the user experience and tailor the advertisements based on the user's behavior or actions rather than just based on requested information and/or applications. Thus, advertising manager 108 can perform calculations on the fly based on inferences of what the user would like to view, the user's interests, as well as other observations.

For example purposes and not limitation, the user might use a spreadsheet application for four hours a day. Advertising manager 108 can go beyond this usage information and determine that the user is performing square root calculations within the spreadsheet application. These square root calculations are specific to the internal application and are what the user is actually doing with the application. This detailed usage information can be utilized to suggest square root macros (in the form of an advertisement) that might make it easier for the user to perform the square root functions. Thus, the application specific data can provide a spectrum of knowledge that can be utilized to tailor the advertisement to the user. The application log interface 212 functionality can gather/access the advertisement based on the modifications determined by advertising manager 108.

Analysis component 104 can establish trends based on the observed behaviors. To establish trends, applications can be placed in various categories such as business, personal, and so forth. For example, if the user utilizes a spreadsheet application, that spreadsheet application might be grouped under a business category. This same user might utilize a word processing application and the word “math” or its equivalents are used frequently when drafting and/or reviewing documents, which can also be categorized under the business category. The two pieces of application data specific information (one from each application) put together can result in more useful information and more detailed information about the user. Advertisements relating to this specific data can be pushed to, or pulled down onto, the device 200. Thus, based on the trend (math applications in the above example), the described aspects allow further tailoring of advertisements.

In another example, video data can be captured. The captured data can include the buffering time and how frustrated the user may be with the buffering time. The information can be inferred or the user can be presented a pop-up ad, during the buffering, asking, for example, if the user is satisfied with the performance. A targeted advertisement can be presented, during the buffering time or at other times for a device that has a higher speed, if the user is not satisfied with the current device. In another example, a user might be experiencing network problems and can be presented an advertisement that states that within the next x days (where x is an integer) the user can receive a discount for buying the newest model device. The buffering time and network problems are examples of application level or application specific data.

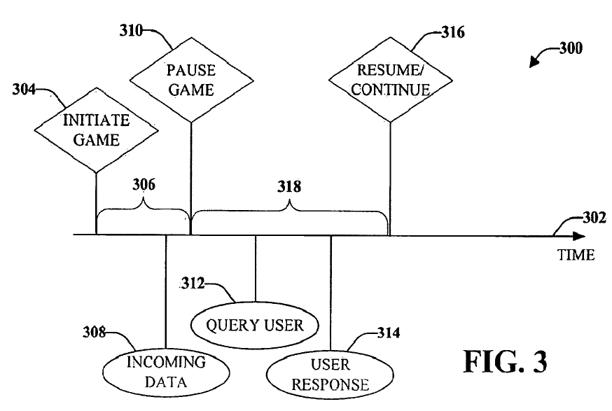

FIG. 3 illustrates viewable data and hidden data as represented in a timeline 300 for an example gaming application. In accordance with some aspects, application specific data includes viewable data, hidden data, or combinations thereof. The hidden data can include data known by an application and/or data that is not known and/or cannot be accessed by an application but is known/accessible by one or more processing subsystems. Thus, some hidden data is available to an application executing functions on the device and other hidden data is not available to the executing application. Thus, the hidden data can be data corresponding to a sequence of processing subsystem level events related to an application level event. Therefore, the executing application might not know all of the details associated with all the processes occurring on the user device. However, the hidden data is able to be stored and retrieved, such as from a processing subsystem.

In the example gaming application illustrated by the timeline 300 in FIG. 3, where time is represented by the horizontal axis 302, there is a gaming application executing on a user device, such as a mobile phone or other communication device. The gaming application is not aware of the underlying communication activities (e.g., voice call, text message, and the like) that are received.

At 304, a game is initiated, such as through a user request. During the time period represented at 306 the game is operated and the gaming application can monitor user behaviors and/or interactions with the game and gather application specific data (e.g., hidden data known by the application). While the game is being played, incoming data is received (by a processing subsystem), at 308. The incoming data can be, for example, a voice call, an instant message, a text message, and so forth. The gaming application is not aware of the receipt of this information; however, the gaming application receives an indication to pause the game, at 310. This indication can be received from other applications and/or processing subsystems executing on the device. The processing subsystem might not inform the gaming application as to why the game was paused, just that the game should be paused. Thus, the information related to why the game is paused is hidden data not available to the application.

The processing subsystem can query the user, at 312, to inform the user that there is an incoming communication and ask whether or not the user wants to accept the incoming communication. Based on the user response 314, the processing subsystem can gather application specific data that can be utilized to tailor advertisements for the user. For example, if the user does not accept incoming communications but rather chooses to ignore the incoming communications while playing a particular game, it can indicate that the user is enthusiastic about the game. As such, advertisements might be provided for a tournament or for other games similar to the current game.

At 316, the gaming application can be instructed to resume and/or continue the game. During the time period indicated at 318, the gaming application is not aware of the activities by the user and/or the processing subsystem. However, the processing subsystem can gather corresponding application specific data (e.g., data that relates to the reason the game was paused, not the data related to the game), at any time (e.g., during game activity as well as other times).

In accordance with some aspects, the application specific data gathered by the processing subsystem can be utilized in conjunction with the application specific data obtained from the gaming application to tailor the advertisement. For example, if a user score is lower than the typical score for this user when there are numerous incoming communications an advertisement can be presented for a software package that can be purchased so that the user will not be disturbed when a phone call or message arrives (e.g., the game will not be paused). In another example, if the game was paused, at 310, due to allow battery power indicator, an advertisement can be provided that relates to a larger battery or more battery power.

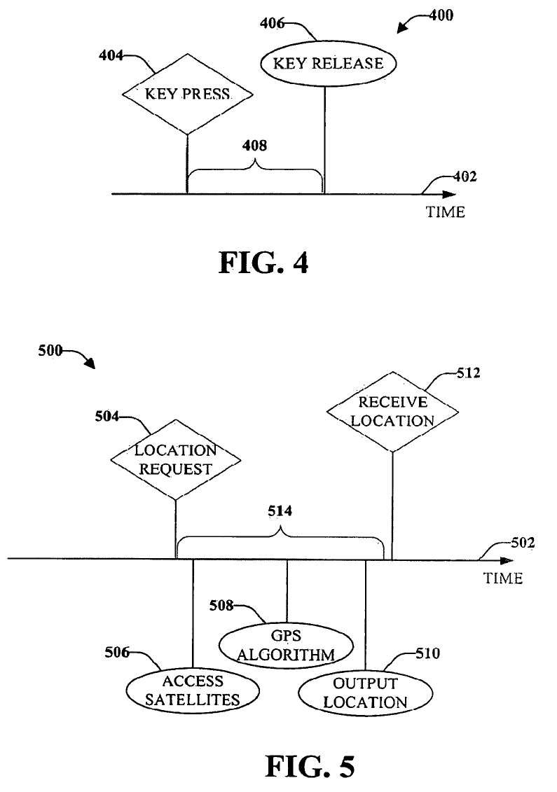

FIG. 4 illustrates an example time line 400 for a key press utilized by a gaming application. In this example, a user presses a key or a combination of keys to play a game. Time is illustrated along the horizontal axis, at 402. At 404, a key press is received. For example, the user can press and quickly release the key (or combination of keys) or the user can press and hold the key(s). At substantially the same time as the key is pressed, the gaming application is provided information as to the action (e.g., pressing of the key). The application specific data relating to when the key is released 406 is known to the processing subsystem. The gaming application does not need to know the details of how long the key is being held (illustrated at 408), when the key is being released 406, etc. Thus, the gaming application just knows that the key is pressed and held (at 404) but not the liming information (at 408). The detailed timing information is an example of application specific data that is not known by the gaming application but can be known by processing subsystems and utilized, either separately or in conjunction with other application specific data, to provided targeted advertisements.

With reference now to FIG. 5, illustrated is another example timeline 500 of information relating to a mapping application, wherein time is illustrated long the horizontal axis 502. It should be understood that the various aspects disclosed herein can relate to numerous applications and are not limited to a gaming application, a mapping application, or other applications discussed within this detailed description as there are many other applications, not discussed herein, that can be utilized to provide targeted advertisements.

In this example, a location request is received from a user, at 504. In order to obtain the location, the mapping application can access an application programming interface (API) that can access one or more satellites 506 and/or apply a GPS algorithm 508 and provide the location to the mapping application, at 510. This location can be received by the mapping application, at 512, and presented to the user.

Hidden data that is not available to the user can include a latitude/longitude or other geographic coordinates relating to the location of the user. That is to say, the geographic coordinates might not be displayed on a screen however, the mapping application is aware of the geographic coordinates, in accordance with some aspects.

The processes occurring during the time period indicated at 514 is not known by the mapping application (or the user). Thus, the mapping application is not aware of how many satellites were accessed, at 506. The mapping application also might not be aware of the GPS algorithm 518 utilized to obtain the geographic coordinates. In accordance with some aspects, the mapping application docs not know the accuracy of the location information. Therefore, this hidden data is not available to mapping application but is available to a processing subsystem, which can gather application specific data relating to these functions. Hidden data, viewable data, or combinations thereof can be utilized to provide targeted advertisements in accordance with the disclosed aspects.

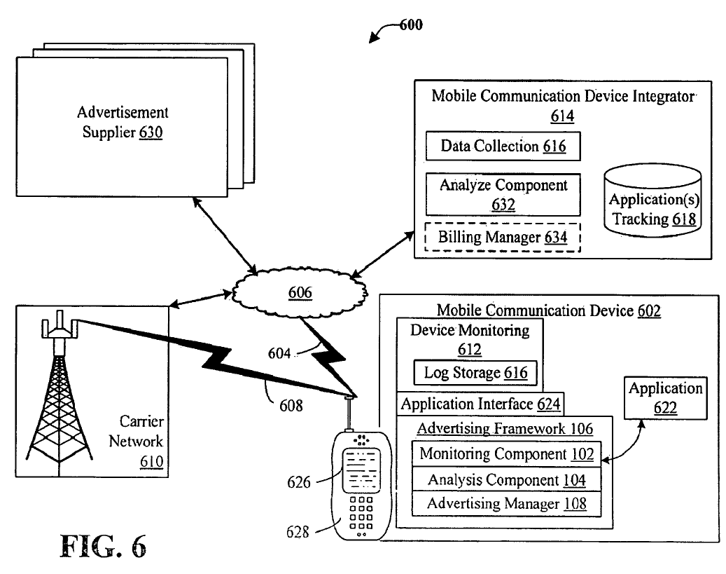

67J Referring to FIG. 6, a communication system 600 includes a wireless device, depicted as mobile communication device 602. Although only one mobile communication device 602 is illustrated, there can be multiple mobile communication devices within communication system 600. However, only one device is illustrated and described for simplicity purposes. Mobile communication device 602 communicates with network, illustrated as a wireless data packet communication channel depicted at 604 with a data network 606 and/or cellular communication channel depicted at 608 with a carrier network 610. At least one mobile communication device 602 includes a device monitoring component 612 that relays device information (e.g., application usage information, application specific data, trends, and so forth) through one of the communication channels 604, 608 to a mobile communication device integrator 614 that is in communication through the data network 606.

Data collection processes 616 stored in an application tracking database 618 by the integrator 614 can be utilized to target advertisements for communication device 602, in part, based on observed actions and activities detected by an advertising (ad) framework 106. Thus, the application tracking database 618 can maintain information relating to the application data and the application specific data. The application specific data can be mapped to a targeted advertisement.

To further the capabilities of the mobile communication device 602, it can be desired to add a third-party application 622 (e.g., installed by the original equipment manufacturer (OEM), wirelessly downloaded by the user, and so forth.). Typically a large variation can exist in a population of mobile communication devices 602 in chipset, hardware, and/or software execution environment for the application 622. Thus, an application interface 624 incorporated into the communication device 602 can provide an execution environment that is substantially platform independent, such as facilitating access by the application 622 with an output device, depicted as a display screen 626, and to an input device, depicted as a keypad 628. Often, however, it is desirable to limit or prevent further interaction by the application 622 with other capabilities of the communication device 602 to prevent inadvertent or malicious interference with device performance or user privacy.

An advertisement supplier 630 can receive information relating to a user of mobile communication device 602. The information can be observed and captured by a monitoring component 102. The observation can include applications and/or functions accessed by the user. The observation can also include details of the usage, which can include tools or other functionality of the application that is used as well as other user specific data (e.g., words, phrases, shortcut keys, user preferences, and so forth). An analysis component 104 can gather the observed information and categorize the information to determine trends or statistical data. The information can characterize the user (e.g. user preferences, user demographics), categorize the information, and/or characterize the endeavor (e.g., is the device used for business purposes, personal purposes, or both purposes).

An advertising manager 108 can review information relating to various advertisements retained locally on the device 602 or remotely available to the device 602. In accordance with an aspect, advertising manager 108 can retrieve a listing of advertisements and based on certain criteria about the user (e.g., application specific data), can choose one or more advertisements to be presented to the user. The advertisements can be presented through display 626 or through another means (e.g., speaker). Advertising manager 108 can also interact with advertisement supplier 630 to determine one or more advertisements that might be of interest to the user. Such advertisements can be sent to the device for local storage and later presentation. In accordance with some aspects, the advertisements can be sent to the phone by advertisement supplier 630 and, at substantially the same time, presented to the user and/or retained locally on device 602.

In accordance with some aspects, mobile communication device integrator 614 obtains an advertisement from an advertisement supplier 630 and repackages the advertisement into a standardized format, which is provided to the mobile communication device 602. Additionally or alternatively, mobile communication device integrator 614 provides links (e.g., a URL) that the mobile communication device 602 can access to obtain advertisements. For example, news advertisements can be obtained from a first URL, video game advertisements can be obtained from a second URL, and so forth. The mobile communication device 602 can match the different URLs to different categories and can automatically obtain the advertisements. In accordance with some aspects, the packaging performed by mobile communication device integrator 614 includes generic advertisements and the advertisements directly accessed by mobile communication device 602 represent tailored advertisements. Thus, based on various considerations, the advertising manager 108 might review a library of advertisements and selectively choose the advertisement that should be presented to the user (e.g., by accessing a URL where the advertisement can be found). However, based on other considerations, it might be decided that advertisements in a standardized format should be presented to the user.

Further, mobile communication device integrator 614 can include an analyze component 632 that collects application specific data relating to multiple users and compares that application specific data across different users or populations of users. For example, when a game is first launched mobile communication analyze component 632 can be provided information relating to the game and that the high score is 500. Over time, historical information is gathered per device and analyze component 632 can update the high score on-the-fly if the historical data indicates that the high score is now 900. Thus, the threshold information relating to the high score can be changed based on the information from multiple users.

According to some aspects, mobile communication device integrator 614 may optionally include a billing manager 634 that tracks which advertisements are sent to multiple devices, the number of times an advertisement is sent, and so forth. Advertising revenue can be established based on the values tracked by billing manager 632. It should be understood that billing manager 634 may be a component outside of the mobile communication device integrator 614, although illustrates as internal to integrator 614. According to some aspects, a billing manger 634 is not included in system 600.

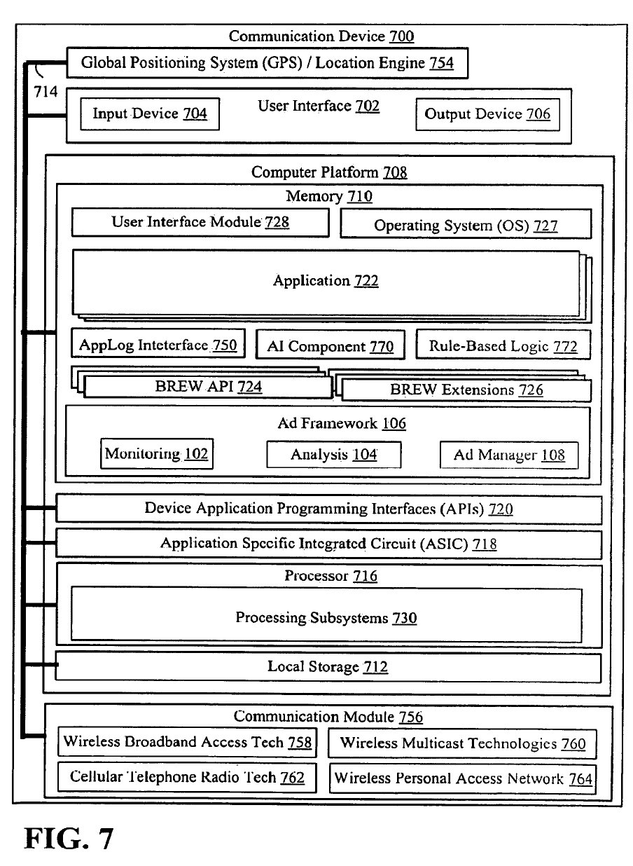

In FIG. 7, an exemplary version of a communication system 700 is depicted according to some aspects as any type of computerized device. For example, the communication device 700 can comprise a mobile wireless and/or cellular telephone. Alternatively, the communication device 700 can comprise a fixed communication device, such as a Proxy Call/Session Control Function (P-CSCF) server, a network device, a server, a computer workstation, and so forth. It should be understood that communication device 700 is not limited to the described or illustrated devices, but can further include a Personal Digital Assistant (PDA), a two-way text pager, a portable computer having a wired or wireless communication portal, and any type of computer platform having a wired and/or wireless communications portal. Further, the communication device 700 can be a remote-slave or other similar device, such as remote sensors, remote servers, diagnostic tools, data relays, and the like, which does not have an end-user thereof, but which simply communicates data across a wireless or wired network. In alternate aspects, the communication device 700 can be a wired communication device, such as a landline telephone, personal computer, set-top box or the like. Additionally, it should be noted that any combination of any number of communication devices 700 of a single type or a multitude of the previously discussed types can be utilized in a cellular communication system (not shown). Therefore, the one or more disclosed aspects can accordingly be performed on any form of wired or wireless device or computer module, including a wired or wireless communication portal, including without limitation, wireless modems, Personal Computer Memory Card International Association (PCMCIA) cards, access terminals, personal computers, telephones, or any combination or sub-combination thereof.

Additionally, the communication device 700 may include a user interface 702 for purposes such as viewing and interacting with advertisements. This user interface 702 includes an input device 704 operable to generate or receive a user input into the communication device 700, and an output device 706 operable to generate and/or present information for consumption by the user of the communication device 700. For example, input device 702 can include at least one device such as a keypad and/or keyboard, a mouse, a touch-screen display, a microphone in association with a voice recognition module, and so forth. Further, for example, output device 706 can include a display, an audio speaker, a haptic feedback mechanism, and the like. Output device 706 can generate a graphical user interface, a sound, a feeling such as a vibration or a Braille text producing surface, and so forth.

Further, communication device 700 can include a computer platform 708 operable to execute applications to provide functionality to the device 700, and which may further interact with input device 704 and output device 706. Computer platform 708 can include a memory, which can comprise volatile and nonvolatile memory portions, such as read-only and/or random-access memory (RAM and ROM), erasable programmable read-only memory (EPROM), electrically erasable programmable read-only memory (EEPROM), flash memory, and/or any memory common to computer platforms. Further, memory can include active memory and storage memory, including an electronic file system and any secondary and/or tertiary storage device, such as magnetic media, optical media, tape, soft and/or hard disk, and removable memory components. In the illustrative version, memory is depicted as RAM memory 710 and a nonvolatile local storage component 712, both connected to a data bus 714 of the computer platform 708.

Further, computer platform 708 can also include a processor 716, which can be an application-specific integrated circuit (ASIC), or other chipset, processor, logic circuit, or other data processing device. Certain of these capabilities of the communication device 700 can be facilitated by code loaded from local storage 712, retained in memory 710, and executed by the processor 716. In some aspects, such as when communication device 700 comprises a cellular telephone, processor or other logic such as an application specific integration circuit (ASIC) 718 can execute an application programming interface (API) 720 that interfaces with any resident software components, depicted as applications (e.g., games) 722 that can be active in memory 710 for other functions (e.g., communication call control, alarm clock, text messaging, and so forth). Device APIs 720 can be a runtime environment executing on the respective communication device. One such API 720 runtime environment is BREW API 724. The Binary Runtime Environment for Wireless® (BREW®) software, developed by Qualcomm, Inc. of San Diego, Calif., exists over the operating system 727 of a computing device, such as a wireless cellular phone. BREW® software can provide a set of interfaces to particular hardware features found on computing devices. The BREW APIs 724 provide the ability for applications to call Device APIs 720 and other functions without having to be written specifically for the type of communication device 700. Thus, applications 722, if composed in BREW, or other software components on the communication device 700 can operate identically, or with slight modifications, on a number of different types of hardware configurations within the operating environment provided by BREW API 724, which abstracts certain hardware aspects. A BREW extension 726 adds additional capability to the programming platform of the BREW API 724, such as offering MP3 players, Java Virtual Machines, and so on.

As an example, a User Interface module 728 can be a brew extension 726, leveraging a uiOne delivery system (UDS) as part of a network. The uiOne™ architecture also developed by Qualcomm, Inc. as part of BREW provides a set of BREW extensions 726 that enable rapid development of rich and customizable User Interfaces (UIs) (active content, over-the-air (OTA) up-gradable), helps to evolve download business beyond applications, provides theming of part or entire handset UI, and utilizes BREW UI Widgets. Thus, BREW uiOne reduces the time to market for handsets, carrier customization, and consumer personalization. To do this, the BREW uiOne provides a clear set of abstractions, adding two new layers to the application development stack for BREW. The uiOne delivery system is used to update communication device UIs over-the-air. This delivery system can be deployed in a standalone fashion, allowing operators to leverage the functionality of their own delivery system. Additional benefits can be realized by deploying uiOne architecture with uiOne delivery system, especially when deployed in conjunction with other elements of the BREW solution (e.g., monetization and billing of downloadable UI packages when the operator does not already have the appropriate infrastructure).

Additionally, processor 716 can include various processing subsystems 730 embodied in hardware, firmware, software, and combinations thereof, that enable the functionality of communication device 700 and the operability of the communication device 700 on communications system. For example, processing subsystems 730 allows for initiating and maintaining communications, and exchanging data, with other networked devices as well as within and/or among components of communication device 700. In one aspect, such as in a cellular telephone, processor 716 can include one or a combination of processing subsystems 730, such as: sound, non-volatile memory, file system, transmit, receive, searcher, layer 1, layer 2, layer 3, main control, remote procedure, handset, power management, diagnostic, digital signal processor, vocoder, messaging, call manager, Bluetooth® system, Bluetooth® LPOS, position determination, position engine, user interface, sleep, data services, security, authentication, USIM/SIM (universal subscriber identity module/subscriber identity module), voice services, graphics, USB (universal serial bus), multimedia such as MPEG (Moving Picture Experts Group) protocol multimedia, GPRS (General Packet Radio Service), short message service (SMS), short voice service (SVS™), web browser, and so on. For the disclosed aspects, processing subsystems 730 of processor 710 can include any subsystem components that interact with applications executing on computer platform 708.

The illustrative depiction of the processing subsystems 730 wherein the communication device 700 is a cellular telephone, processing subsystems 730 can include one or more of a receive (“Rx”) component for receiving communications sent to the processor of the wireless device, a call processing (“CP”) component and/or system determination (“SD”) component for handling the initiation, authentication, handoffs, data exchanges, messaging protocols, internal processing and decision-making, etc. associated with processing a message, and a transmit (“Tx”) component for sending communications from the processor of the wireless device, such as to handset components, wireless network, wireless network components, and other devices connected to the wireless network. In accordance with some aspects, CP component can handle the majority of the call processing tasks, while SD component can handle tasks relating to selecting an appropriate system, from a multitude of systems, with which to communicate, as well as higher-level decision-making tasks referenced by CP component. In addition, processing subsystems 730 can further include one or more of a diagnostic (“Dx”) component for evaluating a subsystem, a fax (“Fx”) component for handling facsimile communications, a call manager (“CM”) component for characterizing and logging call types, a messaging component (“M”) for text sending and receiving, and a data services (“DS”) component for processing all data-related communications, such as establishing and maintaining datacalls.

An Application Log (AppLog) Interface 750 can gather (e.g., collect, receive, and so forth) activities and application specific data and generate reports for reporting to a network and/or third party. Such information can enhance the value of targeted advertisements. Further information relating the Application Log Interface are disclosed in U.S. patent application Ser. No. 11/962,041 entitled “APPLICATION LOGGING INTERFACE FOR A MOBILE DEVICE”, having Attorney Docket No. 051026, assigned to the assignee hereof, and hereby incorporated by reference.

Computer platform 708 can further include a GPS engine 754 or other location sensing components to provide location information of the communication device 700. The AppLog interface 750 can augment the log reporting with device monitoring information such as the location of the device. The AppLog interface 750 can filter out user identifying information, for example, so that the value of the advertising does not violate the extent of privacy given to this communication, yet the location of such log reports can give context to the information.

For example, based on the location of the device, it might be noticed that a first coffee shop is being entered and/or is starting to be utilized for wireless coverage. While observing the location of the device, it might also be noticed, based on the application specific details that: wireless coverage offered to the device is slow or has other problems. Thus, a competitor second coffee shop might present a targeted advertisement, based on the location of the device 700 and the application specific details (e.g., less than ideal wireless coverage). The advertisement, could inform the user that a more robust and/or discounted wireless coverage can be realized at a coffee shop (e.g., the competitor second coffee shop) that is half a mile away. These advertisements might only be targeted for patrons of the first coffee shop, while such patrons are in the coffee shop and one or more problems with wireless coverage are detailed by observing the application specific details.

A communications module 756 that enables communications among the various components of communication device 700, as well as being operable to communications related to receiving advertisements, including targeted advertisements. Communications module 756 can be embodied in hardware, firmware, software and/or combinations thereof, and may further include all protocols for use in intra-device and inter-device communications. In one aspect, the communication module 756 includes a wireless broadband access technology portion 758, a wireless multicast technology portion 760, a cellular telephone radio technology portion 762, and a wireless personal access network portion 764. Examples of two-way wireless broadband access technology portion 758 can include one or more of a wireless code division multiple access (W-CDMA) component, an Evolution-Data Optimized (EV-DO) component, an IEEE 802.11 compliant (often mischaracterized by the trademark WiFi) component. An example of a wireless personal access network technology portion 764 includes a Bluetooth component. Examples of a wireless multicast technology portion 760 include a Forward Link Only (FLO) component and/or a Digital Video Broadcast-Handheld (DVB-H) component.

The communication module 756 can be accessed by an advertising framework 106 that reports application specific data (including trends) to a network through AppLog Interface 750, in one aspect. The advertising framework 106 can include a monitoring component 102 that can observe application information and how the application is being consumed by a user (e.g., application specific details). An analysis component 104 can gather the observed information and categorize the information, characterize the user, characterize the endeavor, or combinations thereof. The monitoring component 102 or analysis component 104 can communicate the information amongst themselves, to other devices, across a network, and so forth. In accordance with an aspect, the information is communicated to AppLog Interface 750. In accordance with some aspects, the information can be transmitted between applications and/or to other network devices in various manners (e.g., shared memory, messaging).

Another component associated with the advertising framework 106 is an advertisement manager 108 that determines which advertisements should be obtained based on the information from monitoring component 102 and/or analysis component 104. Advertisements can be pre-downloaded and retained in cache or memory 710 and output to the user, through output device 706.

In order to target advertisements utilizing application specific data, an artificial intelligence (AI) component 770 and/or a rule-based logic component 772 can infer user behavior for reporting application specific data, make decisions as to when an observed user behavior has changed, to track trends, and/or to infer other information that can be utilized to target advertisements.

The rules-based logic component 772 can he employed to automate certain functions described or suggested herein. In accordance with this alternate aspect, an implementation scheme (e.g., rule) can be applied to define types of attributes that should be acted upon or ignored, create rules that are aware of location sensing status, performance delays in certain components of the computing platform in order to present an advertisement targeted for the user, and so forth. By way of example, it will be appreciated that the rule-based implementation can automatically define criteria for when to present an advertisement. Criteria can also be defined for the manner in which the advertisement should be presented (e.g., pop-up ad, movie clip, voice only, and so forth) as well as where the present the ad (e.g., full-display, a sub-portion of the display, and so on).

The AI component 770 can facilitate automating performance of one or more features described herein such as learning what is normal and abnormal behavior of the user as it relates to applications, learning the specific interactions the user performs with the various applications, and adjusting one or more presented advertisements based on changes in a user's actions and based on machine learning. Thus, employing various AI-based schemes can assist in carrying out various aspects thereof.

A classifier is a function that maps an input attribute vector, x=(x1, x2, x3, x4, xn), to a class label class(x). A classifier can also output a confidence that the input belongs to a class, that is, f(x)=confidence(class(x)). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs that splits in an optimal way the triggering input events from the non-triggering events. Other classification approaches, including Naive Bayes, Bayesian networks, decision trees, neural networks, fuzzy logic models, maximum entropy models, etc., can be employed. Classification as used herein also is inclusive of statistical regression that is utilized to develop models of priority.

As will be readily appreciated from the subject specification, the disclosed aspects can employ classifiers that are pre-trained (e.g., through a generic training data from multiple users) as well as methods of reinforcement learning (e.g., by observing user behavior, observing trends, receiving extrinsic information). Thus, the disclosed aspects can be used to automatically learn and perform a number of functions, including but not limited to determining, according to a predetermined criteria.

The memory can store information related to capturing application specific details arid utilizing the captured application specific details to characterize a user, characterize an endeavor, categorize an application, or combinations thereof. In accordance with some aspects, capturing the application specific details can include obtaining at least one behavior associated with a user. The behavior can include, but is not limited to, gaze patterns, usage patterns, and so forth.

The memory can also store information relating to choosing one or more advertisements based on one or more of the characterization and categorization and outputting the one or more advertisements. In accordance with some aspects, outputting the one or more advertisements comprises displaying the advertisements in a selectable sub-portion of a display screen. The sub-portion of the display screen can be manually selected by a user or based on other criteria (e.g., advertiser choices, applications currently open on the device, and so forth). The one or more advertisements can be saved locally on a user device, accessed from a network, or combinations thereof.

The memory can further retain instructions relating to continuing to monitor the application specific details. The monitoring can be on at least a periodic basis and, in some cases, can be continuous monitoring. The memory can also retain instructions relating to requesting a change to at least one of the advertisements, based on the monitoring. The change can be tailored for the user such that an advertisement transitions from a general or generic advertisement to a more narrowly tailored or targeted advertisement.

Additionally, the memory can retain instructions relating to reporting log reports that include information relating to the application specific details, the one or more advertisements, or combinations thereof. Additionally or alternatively, the memory can retain instructions relating to establishing at least one trend based on the captured application specific details and determining a change for at least one of the advertisements. The trend can be associated with the application, the user, the endeavor, or combinations thereof.

The processor 716 can facilitate analysis of information related to targeted advertising in a communication network. Processor 716 can be a processor dedicated to analyzing and/or generating information received by communication device 700, a processor that controls one or more components of device 700, or combinations thereof. Memory can store protocols associated with targeted advertising, such that device 700 can employ stored protocols and/or algorithms to achieve improved advertisement techniques in a wireless network as described herein.

In view of the exemplary systems shown and described above, methodologies that may be implemented in accordance with the disclosed subject matter, will be better appreciated with reference to the following flow charts. While, for purposes of simplicity of explanation, the methodologies are shown and described as a series of blocks, it is to be understood and appreciated that the claimed subject matter is not limited by the number or order of blocks, as some blocks may occur in different orders and/or concurrently with other blocks from what is depicted and described herein. Moreover, not all illustrated blocks may be required to implement the methodologies described hereinafter. It is to be appreciated that the functionality associated with the blocks may be implemented by software, hardware, a combination thereof or any other suitable means (e.g. device, system, process, component). Additionally, it should be further appreciated that the methodologies disclosed hereinafter and throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

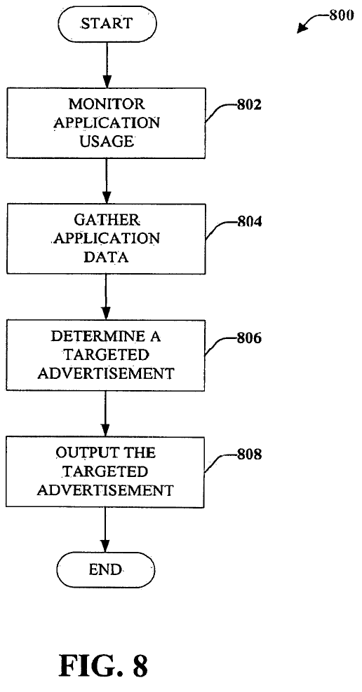

FIG. 8 illustrates a method 800 for providing targeted advertisements. Application specific data or internal data related to an application can be gathered and predefined advertisements can he delivered to a mobile device based on the gathered data. For example, when a user is browsing a “Mapping Web Site”, and the browser provides an internal status, such as “browsing mapping web site now”, the status is captured. Based on the captured status, a pre-downloaded advertisement configuration can be searched for one or more appropriate advertisements, which are presented to the user.

Method 800 starts, at 802, when application usage information is monitored. The application usage information can include the type of applications accessed, the usage frequency, the time of day/week each application is accessed, as well as other data. The application usage information can also include application specific data that can include, but is not limited to, analysis of words and/or phrases, algorithms, preferences, and other parameters as they relate to a user and/or device (e.g., location of the user/device, performance of the device, and so forth). In accordance with some aspects, monitoring the application specific data includes obtaining user behavior information (e.g., gaze patterns, hovering with a mouse or other pointing device, and so on).

Further, application specific data can be viewable data, hidden data, or combinations thereof. Viewable data is data that, a user can perceive. Hidden data is data not known (or not visible) to a user but is known to an application and/or a processing subsystem (e.g., not known to the application). Examples of hidden data known by the processing subsystem, but not the application, include a sequence of interactions or events that lead to a higher level event. As such, the hidden data is data corresponding to a sequence of processing subsystem level events that are related to an application level event. The hidden data is storable by and retrievable from the processing subsystem.

Another example of hidden data is when a user requests to initiate a call. The user knows that the application is making a connection, however, the user does not realize that the data connection is attempted a number of times before the call, is accomplished. Thus, the number of attempts is an example of hidden data.

At 804, application data that includes both the types of applications and the specific application information is gathered. The gathered data can be utilized to categorize the information, characterize the user, characterize the endeavor, or combinations thereof. In accordance with some aspects, one or more trends can be determined based on the gathered application information. For example, the trends can indicate that certain applications or functionality within an application is utilized only during certain portions of a day (e.g., work hours) while other applications and/or functionality is utilized during other portions of the day (e.g., non-work hours). These trends can be utilized to tailor advertisements based on the activities in which the user is engaged (e.g., work activities, non-work activities).

An advertisement that is targeted for the user is determined, at 806. The targeted advertisement can be determined, in part, based on the application specific data. The advertisements can begin as generic applications, such as when a user accesses a new device. Over time the advertisements can become more specific or more targeted for the user as further information about the user and/or device are discovered. For example, the application specific data can provide information about the activities of the user, the words the user is inputting (e.g., typing, speaking), the data being generated, and so forth.

In accordance with some aspects, the advertisement is determined based on algorithms, heuristics, neural networks, and so forth that map application specific data to an advertisement. For example, the application specific data can be metadata and a particular advertisement can be pushed to the user device based on the metadata. For example, the metadata can indicate that in a web browser a user is pressing “stop” frequently, which can be a predetermined value. Metadata can also include information that indicates the user accesses the history feature often, which can indicate that the history of this user should be indexed more often. If the metadata can be matched to an advertisement, that advertisement is selected.

Additionally or alternatively, the advertisements can be determined or selected based on advertiser criteria. For example, an advertiser can specify that a particular advertisement should be presented to the user when certain criteria is established. For example, for a gaming application an advertisement might be selected for presentation to the user when an established “high” score is achieved or when the user has advanced to a certain “level” within the game (e.g., advertisement for a virtual competition). In accordance with another example, an advertisement can be presented after a predefined interval if the user has not shown skill-level progress within the game (e.g., provide advertisements for skill training).

The advertisement selected can be an advertisement that was previously downloaded and saved (e.g., retained locally) on the device. In accordance with some aspects, one or more of the advertisements could have been saved on the device during assembly of the device (e.g., before user possession of the device). According to some aspects, the one or more advertisements could be sent to the device over a network based on information received that relates to the applications and/or the application specific data.

The targeted advertisement is presented to the user, at 808. The advertisement can be presented in various forms including visually (e.g., still picture, video clip, and so forth), audibly, or combinations thereof. In accordance with some aspects, one or more advertisements can be displayed in a designated portion of a display screen. The portion of the screen can be selected manually by the user and/or it can be selected automatically based on device capabilities, the applications running on the device, advertiser preferences, a pre-designated portion, or based on other criteria.

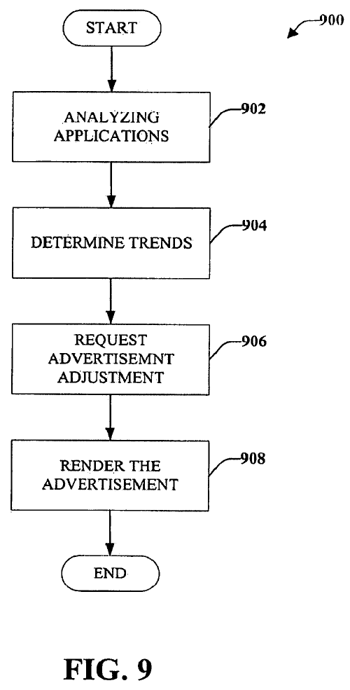

FIG. 9 illustrates a method 900 for determining one or more advertisements to present to a user. At 902, application specific details are analyzed. These details can relate to the applications and/or functions utilized as well as the details or internal functionality accessed within those applications (e.g., which “tools” does the user consistently use). At 904, trends associated with the application, user, and/or endeavor are determined. Such trends can indicate preferences or needs of the user (e.g., enjoys one news program over another news program, watches a news program to learn details about the television station broadcasting the news). The application trends can indicate cross-functionality between applications that might or might not be apparent without the trend data. The trends associated with the endeavor can relate to projects or activities engaged in by the user.

Based on the trends, adjustments to one or more advertisements can be made, at 906. The adjustments include obtaining new advertisements that are more specific or more tailored to the user. In accordance with some aspects, as new advertisements are obtained, older advertisements that are more generic can be removed from memory. The advertisements can be accessed and downloaded to the device during an idle time or during pre-designated times (e.g., from 3 a.m. to 6 a.m.). If the advertisements are retained locally on the device, the advertisements can be dynamically rendered to the user, at 908. In accordance with some aspects, one or more advertisements are not retained locally on the device but are accessed by device, such as over a network, and output to the user. In accordance with some aspects, the targeted advertisements can be displayed in a sub-portion of the display area, allowing a user to perform actions with the device at substantially the same time as the advertisement is rendered.

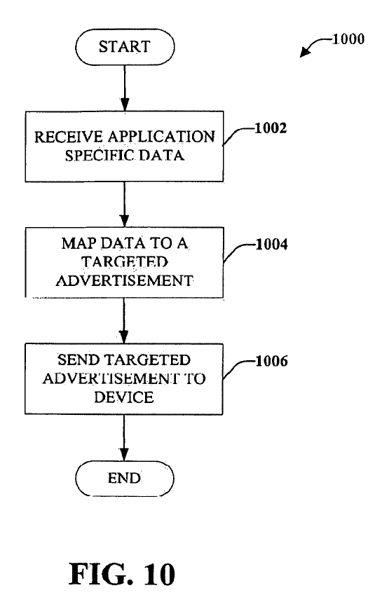

FIG. 10 illustrates a method 1000 for providing targeted advertisements. Method 1000 starts at 1002 when application specific data is received from a mobile device. The application specific data can be generated by a program, input by a user, specifically for use by a program, used in execution of an application, or combinations thereof. The application specific data is viewable data, hidden data, or combinations thereof. In accordance with some aspects, the application specific data is hidden data that is not available to a user. According to other aspects, the application specific data is not available to an application but is available to a processing subsystem. In accordance with other aspects, the application specific data is available to an application.

At 1004, the application specific data is mapped to a targeted advertisement. For example, the application specific data can be metadata that can indicate that in a web browser a user is pressing “stop” frequently, which can be a predetermined value. Metadata can also include information that indicates the user accesses the history feature often, which can indicate that the history of this user should be indexed more often. The metadata can be mapped to an advertisement.

At 1006, the targeted advertisement is sent to the mobile device for presentation to the user if the application specific data was mapped to an advertisement. In accordance with some aspects, a generic advertisement is sent to the mobile device if the application specific data was not mapped to an advertisement. In accordance with some aspects, a message is sent to the mobile device. The message includes an identification of where the mobile device can obtain the tailored advertisement.

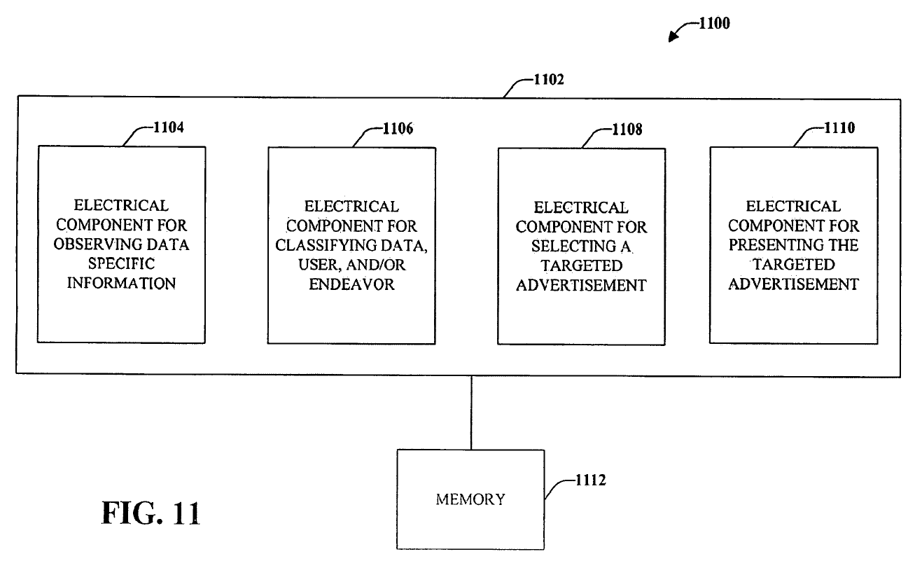

With reference to FIG. 11, illustrated is an example system 1100 that provides targeted advertising in accordance with the one or more aspects described herein. For example, system 1100 may reside at least partially within a mobile device. It is to be appreciated that system 1100 is represented as including functional blocks, which may be functional blocks that represent functions implemented by a processor, software, or combination thereof (e.g., firmware).

System 1100 includes a logical grouping 1102 of electrical components that can act separately or in conjunction. Logical grouping 1102 can include an electrical component for observing specific data associated with one or more applications 1104. The observation can include user behavior information, such as eye gaze patterns, pointing device patterns (e.g., hovering), repeated functionality or repeated commands, and so forth. Also included in logical grouping 1102 can be an electrical component for classifying one or more of the specific data, a user, or an endeavor 1106. Trends as it relates to the specific data; the user, or the endeavor can also be determined to more narrowly focus an advertisement.

An electrical component for selecting a targeted advertisement 1108 and an electrical component for presenting the target advertisement 1110 are also included in logical grouping 1102. In accordance with some aspects, based on the trends, electrical component 1108 can selectively adjust the targeted advertisements, such as by requesting a more specific advertisement, wherein a previously presented advertisement was considered a generic advertisement. The electrical component for presenting the target advertisement 1110 can present the advertisement visually, verbally, or combinations thereof. The visual presentation can be in a pre-designated portion of a display screen.

The electrical component for observing 1104 can continuously monitor the usage and specific data and, based on such monitoring, the electrical component for selecting a targeted advertisement 1106 can transition the advertisement from a generic advertisement to a specific advertisement. In accordance with some aspects, the continuous monitoring can be performed at periodic intervals. The targeted advertisement can be retained locally on a user device, accessed through a network, or combinations thereof. Additionally or alternatively, logical grouping 1102 can include an electrical component (not shown) for selectively collecting and wirelessly reporting log reports related to the gathered data and the targeted advertisement.

Additionally, system 1100 can include a memory 1112 that retains instructions for executing functions associated with electrical components 1104, 1106, 1108, and 1110 or other components. While shown as being external to memory 1112, it is to be understood that one or more of electrical components 1104, 1106, 1108, and 1110 can exist within memory 1112.

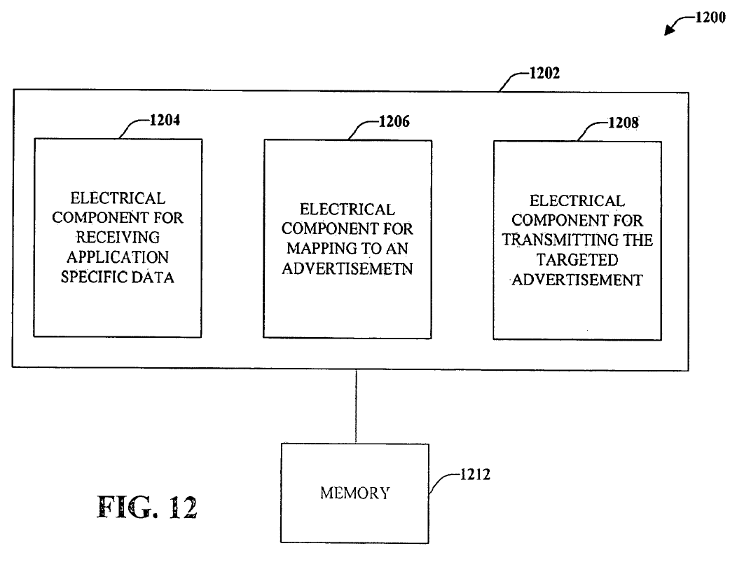

FIG. 12 illustrates an example system 1200 that provides targeted advertising in accordance with the one or more aspects described herein. It is in be appreciated that system 1200 is represented as including functional blocks, which may be functional blocks that represent functions implemented by a processor, software, or combination thereof (e.g., firmware).

System 1200 includes a logical grouping 1202 of electrical components that can act separately or in conjunction. Logical grouping 1202 can include an electrical component for receiving application specific, data 1204 from a mobile device. The application specific data can be generated by a program, can be input by a user, can be specifically for use by a program, and/or can be used in execution of an application.

Also included is an electrical component for mapping the application specific data to a targeted advertisement 1206. Further, logical grouping 1202 includes an electrical component for sending the targeted advertisement to the mobile device 1208 for presentation to the user if the application specific data was mapped to an advertisement

In accordance with some aspects, logical grouping 1202 can include an electrical component for sending a generic advertisement to the mobile device if the application specific data was not mapped to an advertisement. Also included in logical grouping 1202 can be an electrical component for sending a message to the mobile device. The message can include an identification of where the mobile device can obtain the tailored advertisement.

Additionally, system 1200 can include a memory 1210 that retains instructions for executing functions associated with electrical components 1204, 1206, and 1208, or other components. While shown as being external to memory 1210, it is to be understood that one or more of electrical components 1204, 1206, and 1208 can exist within memory 1210,

It is to be understood that the aspects described herein may be implemented by hardware, software, firmware or any combination thereof. When implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while-discs reproduce data optically with lasers. Combinations of the above should also be included within the scope of computer-readable media.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may he a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

For a software implementation, the techniques described herein may be implemented with modules (e.g., procedures, functions, and so on) that perform the functions described herein. The software codes may be stored in memory units and executed by processors. The memory unit may be implemented within the processor or external to the processor, in which case it can be communicatively coupled to the processor through various means as is known in the,art. Further, at least one processor may include one or more modules operable to perform the functions described herein.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), CDMA2000, etc. UTRA includes Wideband-CDMA (W-CDMA) and other variants of CDMA. Further, CDMA2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM°, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, CDMA2000 and UMB are described in documents from on organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Moreover, various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product may include a computer readable medium having one or more instructions or codes operable to cause a computer to perform the functions described herein.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

While the foregoing disclosure discusses illustrative aspects and/or aspects, it should be noted that various changes and modifications could be made herein without departing from the scope of the described aspects and/or aspects as defined by the appended claims. Accordingly, the described aspects are intended to embrace all such alterations, modifications and variations that fall within scope of the appended claims. Furthermore, although elements of the described aspects and/or aspects may be described or claimed in the singular, the plural is contemplated unless limitation to the singular is explicitly stated. Additionally, all or a portion of any aspect and/or aspect maybe utilized with all or a portion of any other aspect and/or aspect, unless stated otherwise.

To the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description of the claims is meant to be a “non-exclusive or”.

What is claimed is:

1. A method for providing targeted advertisements, comprising:
monitoring application specific data;
gathering the data to categorize the data, characterize a user, characterize an endeavor, or combinations thereof;
determining an advertisement that is targeted for the user based on the gathered data; and
outputting the targeted advertisement.

2. The method of claim 1, wherein the application specific data is generated by a program.

3. The method of claim 1, wherein the application specific data is input by a user.

4. The method of claim 1, wherein the application specific data is specifically for use by a program.

5. The method of claim 1, wherein the application specific data is data used in execution of an application.

6. The method of claim 1, wherein the application specific data is data hidden from a user.

7. The method of claim 6, wherein the hidden data is data corresponding to a sequence of processing subsystem level events related to an application level event and not available to an application.

8. The method of claim 6, wherein the hidden data is available to an application.

9. The method of claim 1, wherein the application specific data is viewable data, hidden data, or combinations thereof.

10. The method of claim 1, further comprising:
selectively obtaining the application specific data; and
generating reports related to the application specific data and the targeted advertisement.

11. The method of claim 1, further comprising:
determining one or more trends based on the gathered data; and
requesting an adjustment to a targeted advertisement based on the one or more trends, wherein the one or more trends are associated with the application, the user, the endeavor, or combinations thereof.

12. The method of claim 1, wherein the targeted advertisement is retained locally on a user device, accessed through a network, or combinations thereof.

13. The method of claim 1, wherein outputting the targeted advertisement comprises displaying the targeted advertisement in a pre-designated portion of a screen.

14. The method of claim 1, gathering the data includes obtaining user behavior information.

15. The method of claim 1, further comprising:
continuously monitoring the application specific data; and
transitioning the targeted advertisement from a generic advertisement to a specific advertisement based on the continuous monitoring.

16. A wireless communications apparatus, comprising:
a memory that retains instructions related to capturing application specific details, utilizing the captured application specific details to characterize a user, characterize an endeavor, categorize an application, or combinations thereof, choosing one or more, advertisements based on one or more of the characterization and categorization, and outputting the one or more advertisements; and
a processor, coupled to the memory, configured to execute the instructions retained in the memory.

17. The wireless communications apparatus of claim 16, wherein the application specific data is generated by a program.

18. The wireless communications apparatus of claim 16, wherein the application specific data is input by a user.

19. The wireless communications apparatus of claim 16, wherein the application specific data is specifically for use by a program.

20. The wireless communications apparatus of claim 16, wherein the application specific data is data used in execution of an application.

21. The wireless communications apparatus of claim 16, wherein the application specific data is data hidden from a user.

22. The wireless communications apparatus of claim 21, wherein the hidden data is data corresponding to a sequence of processing subsystem level events related to an application level event and not available to an application.

23. The wireless communications apparatus of claim 21, wherein the hidden data is available to an application.

24. The wireless communications apparatus of claim 16, wherein the application specific data is viewable data, hidden data, or combinations thereof.

25. The wireless communications apparatus of claim 16, the memory further retains instructions related to generating reports that include information relating to the application specific details, the one or more advertisements, or combinations thereof.

26. The wireless communications apparatus of claim 16, the memory further retains instructions related to establishing at least one trend based on the captured application specific details and determining a change for at least one of the advertisements, the trend is associated with the application, the user, the endeavor, or combinations thereof.

27. The wireless communications apparatus of claim 16, wherein the one or more advertisements are saved locally on a user device, accessed from a network, or combinations thereof.

28. The wireless communications apparatus of claim 16, wherein outputting the one or more advertisements comprises displaying the advertisements in a selectable sub-portion of a display screen.

29. The wireless communications apparatus of claim 16, capturing application specific details includes obtaining at least one behavior associated with a user.

30. The wireless communications apparatus of claim 16, the memory further retains instructions relating to continuing to monitor the application specific details on at least a periodic basis and requesting a change to at least one of the advertisements, wherein the change is tailored for the user based on the monitoring.

31. A communications apparatus, comprising:
means for observing specific data associated with one or more applications;
means for classifying one or more of the specific data, a user, or an endeavor;
means for selecting a targeted advertisement; and
means for presenting the targeted advertisement.

32. The communications apparatus of claim 31, wherein the application specific data is hidden data, viewable data, or combinations thereof.

33. The communications apparatus of claim 31, further comprising:
means for selectively collecting and generating reports related to the specific data.

34. The communications apparatus of claim 31, further comprising:
means for determining one or more trends based on the gathered data, the means for selecting the targeted advertisement requests an adjustment to a targeted advertisement based on the one or more trends, wherein the one or more trends are associated with the application, the user, the endeavor, or combinations thereof.

35. The communications apparatus of claim 31, wherein the targeted advertisement is retained locally on a user device, accessed through a network, or combinations thereof.

36. The communications apparatus of claim 31, wherein outputting the targeted advertisement comprises displaying the targeted advertisement in a pre-designated portion of a screen.

37. The communications apparatus of claim 31, wherein the means for observing gathers user behavior information.

38. The communications apparatus of claim 31, the means for observing continuously or periodically observes the usage and the specific data and the means for selecting transitions the targeted advertisement from a generic advertisement to a specific advertisement based on the continuous observation.

39. A computer program product for providing targeted advertisements, comprising a computer-readable medium comprising:
a first instruction operable to cause a computer to collect application specific details;
a second instruction operable to cause a computer to evaluate the details to distinguish user activities;
a third instruction operable to cause a computer to select one or more advertisements targeted for a user based on the evaluated details; and
at least a fourth instruction operable to cause a computer to output the one or more advertisements to the user.

40. The computer program product of claim 39, wherein the application specific data is hidden data, viewable data, or combinations thereof.

41. The computer program product of claim 39, the computer-readable medium further comprising:
a fifth instruction operable to cause a computer to continue to monitor the application usage and application specific data on at least a periodic basis; and
a sixth instruction operable to cause a computer to request changes to the one or more advertisements to transition from a generic advertisement to a specific advertisement based on the monitoring.

42. The computer program product of claim 39, wherein the targeted advertisement is retained locally on a user device, accessed through a network, or combinations thereof.

43. At least one processor configured for providing targeted advertisements, comprising:
a first module for monitoring application specific data;
a second module for gathering the application specific data to categorize the data, characterize a user, characterize an endeavor, or combinations thereof;
a third module for determining an advertisement that is targeted for the user based on the gathered data;
a fourth module for collecting and reporting log reports related to the gathered data and the targeted advertisement;
a fifth module for outputting the targeted advertisement;
a sixth module for continuing to monitor the application specific data at least periodically; and
a seventh module for requesting a change to the targeted advertisement based on the monitoring, wherein the targeted advertisement is retained locally on a user device, accessed through a network, or combinations thereof.

44. The at least one processor of claim 43, wherein the application specific data is hidden data, viewable data, or combinations thereof.

45. A method for providing targeted advertisements, comprising:
receiving application specific data from a mobile device;
mapping the application specific data to a targeted advertisement; and
sending the targeted advertisement to the mobile device for presentation to a user if the application specific data was mapped to an advertisement.

46. The method of claim 45, wherein the application specific data is generated by a program.

47. The method of claim 45, wherein the application specific data is input by a user.

48. The method of claim 45, wherein the application specific data is specifically for use by a program.

49. The method of claim 45, wherein the application specific data is data used in execution of an application.

50. The method of claim 45, wherein the application specific data is data hidden from a user.

51. The method of claim 50, wherein the hidden data is data corresponding to a sequence of processing subsystem level events related to an application level event and not available to an application.

52. The method of claim 50, wherein the hidden data is available to an application.

53. The method of claim 45, wherein the application specific data is viewable data, hidden data, or combinations thereof.

54. The method of claim 45, further comprises:
sending a generic advertisement to the mobile device if the application specific data was not mapped to an advertisement.

55. The method of claim 45, further comprises:
sending a message to the mobile device, the message includes an identification of where the mobile device can obtain the tailored advertisement.

56. A wireless communications apparatus, comprising:
a memory that retains instructions related to receiving application specific data from a mobile device, mapping the application specific data to a targeted advertisement, and sending the targeted advertisement to the mobile device for presentation to the user if the application specific data was mapped to an advertisement; and
a processor, coupled to the memory, configured to execute the instructions retained in the memory.

57. The wireless communications apparatus of claim 56, wherein the application specific data is generated by a program.

58. The wireless communications apparatus of claim 56, wherein the application specific data is input by a user.

59. The wireless communications apparatus of claim 56, wherein the application specific data is specifically for use by a program.

60. The wireless communications apparatus of claim 56, wherein the application specific data is data used in execution of an application.

61. The wireless communications apparatus of claim 56, wherein the application specific data is data hidden from a user.

62. The wireless communications apparatus of claim 61, wherein the hidden data is data corresponding to a sequence of processing subsystem level events related to an application level event and not available to an application.

63. The wireless communications apparatus of claim 61, wherein the hidden data is available to an application.

64. The wireless communications apparatus of claim 56, wherein the application specific data is viewable data, hidden data, or combinations thereof.

65. The wireless communications apparatus of claim 56, the memory further retains instructions relating to sending a generic advertisement to the mobile device if the application specific data was not mapped to an advertisement.

66. The wireless communications apparatus of claim 56, the memory further retains instructions relating to sending a message to the mobile device, the message includes an identification of where the mobile device can obtain the tailored advertisement.

67. A communications apparatus, comprising:
means for receiving application specific data from a mobile device;
means for mapping the application specific data to a targeted advertisement; and
means for sending the targeted advertisement to the mobile device for presentation to the user if the application specific data was mapped to an advertisement.

68. The communications apparatus of claim 67, wherein the application specific data is viewable data, hidden data, or combinations thereof.

69. A computer program product for providing targeted advertisements, comprising a computer-readable medium comprising:
a first instruction operable to cause a computer to receive application specific data from a mobile device;
a second instruction operable to cause the computer to map the application specific data to a targeted advertisement; and
a third instruction operable to cause the computer to send the targeted advertisement to the mobile device for presentation to a user if the application specific data was mapped to an advertisement.

70. The computer program product of claim 69, wherein the application specific data viewable data, hidden data, or combinations thereof.

71. At least one processor configured for providing targeted advertisements, comprising:
a first module for receiving application specific data from a mobile device;
a second module for mapping the application specific data to a targeted advertisement; and
a third module for sending the targeted advertisement to the mobile device for presentation to a user if the application specific data was mapped to an advertisement.

72. The at least one processor of claim 71, wherein the application specific data includes viewable data, hidden data, or combinations thereof.
